(19) United States
(12) Patent Application Publication
(10) Pub. No.: US 2014/0012515 A1
(43) Pub. Date: Jan. 9, 2014

(54) CHROMATOGRAPH MASS SPECTROMETRY DATA PROCESSING DEVICE

(71) Applicant: Shimadzu Corporation, (US)

(72) Inventor: Katsuyuki TANEDA, Kyoto-shi (JP)

(21) Appl. No.: 13/659,237

(22) Filed: Oct. 24, 2012

(30) Foreign Application Priority Data
May 5, 2010 (JP) 2010-109890

(51) Int. Cl. G06F 19/00

(52) U.S. Cl. CPC G06F 19/708
USPC 702/32

(57) ABSTRACT

When an analyst designates an arbitrary component on a component table displayed in a component table display area, an EIC of the characteristic mass in the vicinity of the retention time of the component is created and is displayed in a chromatogram display area. In addition, an actual measurement mass spectrum at the retention time of the designated component and a pure standard mass spectrum of the component are aligned vertically in the same mass axis scale and displayed in a mass spectrum display area. Further, when the mass axis of one of the mass spectra is magnified/reduced by a dragging operation of a mouse or by a magnification/reduction button, the mass axis of the other mass spectrum is concurrently magnified/reduced.

### TECHNICAL FIELD

The present invention relates to a data processing device for processing data collected by a chromatograph mass spectrometer using a mass spectrometer (MS) as a detector for a gas chromatograph (GC) or a liquid chromatograph (LC); more specifically, the present invention relates to data processing technology for a man-machine interface for screen display processing, operation input processing, or the like in a chromatograph mass spectrometer.

### BACKGROUND ART

In GC/MS analysis, various components contained in a test sample are passed through a column and separated over time, and the ions generated from each of the separated components are separated according to their mass-charge ratios (m/z) by a mass spectrograph such as a quadrupole mass filter and detected with a detector. When identifying unknown compounds contained in a sample, scan measurements of prescribed mass ranges (m/z ranges) are ordinarily executed repeatedly in MS, and a mass spectrum is created for each of the scan measurements. A graph in which the intensity determined by adding all of the ion intensities in each mass spectrum is plotted over time is a total ion current chromatogram (TIC).

When identifying a compound corresponding to a peak appearing in this TIC, the retention time indicated by the top of the peak and a characteristic peak pattern of the mass spectrum at the point in time when the peak appears (signal intensity ratio at multiple m/z values) are used. For example, in the device described in Patent Document 1, a compound serving as a candidate for identification corresponding to a chromatogram peak is given based on the retention time. The similarity of the peak pattern of a standard mass spectrum registered in a database and an actual mass spectrum at the position of the chromatogram peak is assessed for that candidate compound, and the compound candidates are narrowed down based on this assessment result. In addition, as described in Non-Patent Document 1, various functions for supporting the identification of compounds by an analyst are provided in commercially available GC/MS data processing software.

Although processing itself such as the calculation of the similarity of mass spectra in the identification described above is performed automatically, the judgment or confirmation of the analyst often becomes necessary during the identification operation. For example, there are often cases in which a peak appearing in a TIC does not originate from a single compound, and contaminant components eluted roughly simultaneously from the GC overlap with the target compound. Therefore, in many cases, an operation in which the analyst determines the possibility of the presence of contaminant components by visually comparing actual measurement mass spectra and a pure standard mass spectrum of the target compound or confirms the peak shape in the vicinity of the retention time of an extracted ion chromatogram (mass chromatogram) with a m/z characteristic to the target compound is indispensible.

However, the conventional device has the problems that, when the analyst performs operations related to the identification described above, it is difficult to compare the actual measurement mass spectra and the standard mass spectrum of the target compound, or the comparison operation is complicated and troublesome. In addition, when the overlapping of components in a single peak of the TIC is suspected, it is necessary to manually input the m/z value in order to display the extracted ion chromatogram to be confirmed, and the operation is not only complicated, but it also causes mistakes.

### PRIOR ART DOCUMENTS

Patent Document 1

Japanese Unexamined Patent Application Publication H9-431992

Non-Patent Document 1

“Features of the GCMS Solution Workstation for a Gas Chromatograph Mass Spectrometer▪Supporting Reliable Component Identification,” [online], Shimadzu Corporation, [search on Apr. 26, 2010], Internet <URL: http://an.shimadzu.co.jp/gemssol3.htm>

### SUMMARY OF THE INVENTION

The present invention was conceived in light of the problems described above, and its purpose is to provide a chromatograph mass spectrometry data processing device capable of improving the efficiency of operations by simplifying the operations performed by an analyst and reducing operational mistakes when performing component identification by analyzing data collected by chromatograph mass spectrometry.

The present invention, which was conceived in order to solve the problems described above, is a chromatograph mass spectrometry data processing device for creating total ion current chromatogram showing changes in total ions over time and actual measurement mass spectra at arbitrary points in time in the chromatogram based on mass spectrum data repeatedly collected over time by chromatograph mass spectrometry and displaying them on a display screen, the device being provided with:

a) a storage means for storing a standard mass spectrum for various components;

b) a spectrum display processing means for arranging the standard mass spectrum and the actual measurement mass spectra of a component designated to be confirmed among the various components stored in the storage means vertically with the same mass axis scale, displaying the spectra on the same screen as the total ion current chromatogram, and concurrently performing magnification/reduction operations on the actual measurement mass spectra and the standard mass spectrum in the mass axis direction; and

c) an extracted ion chromatogram display processing means for receiving an indication of an arbitrary peak in the standard mass spectrum or an actual measurement mass spectrum displayed on the display screen by the spectrum display processing means, creating an extracted ion chromatogram with respect to the mass of the indicated peak based on the mass spectrum data, and displaying the chromatogram on the same screen as the actual measurement mass spectra and the standard mass spectrum.

The chromatograph mass spectrometry data processing device of the present invention can be realized by executing a dedicated computer program for realizing functions corresponding to each of the means described above on a general-purpose computer comprising a display part, an operation part (keyboard, pointing device, or the like), and the like.

In addition, in the chromatograph mass spectrometry data processing device of the present invention, a typically provided database (library) such as the NIST, Wiley, or Drug database, a database created independently by a device manufacturer and provided to a user, or a database created by the measurements of standard substances taken by the user himself may be used as the storage means.

In the chromatograph mass spectrometry data processing device of the present invention, when the analyst designates measurement data to be reanalyzed, for example, the measurement data is read, and a total ion current chromatogram is created and displayed in one area of the display screen. When the analyst designates an arbitrary peak or an arbitrary position appearing in the total ion current chromatogram using a pointing device or the like or specifies the retention time of a compound for which presence or absence is to be confirmed, an actual measurement mass spectrum at the measurement time or the retention time corresponding to the peak or position is created and displayed in another area on the display screen.

On the other hand, the spectrum display processing means reads out a standard mass spectrum of the component designated to be confirmed from the storage means and displays it in a region prepared directly above or below using the same mass axis scale as the actual measurement mass spectrum. Magnification/reduction operations of both mass spectra are performed concurrently in the mass axis direction, and when the analyst performs a magnification or reduction operation in the mass axis direction of one of the mass spectra, the mass axis of the other mass spectrum is also magnified or reduced by the same amount. Accordingly, the scales of the mass axes of the two upper and lower mass spectra are always aligned. Therefore, the analyst can easily and accurately compare the intensity patterns of the actual measurement mass spectrum and the standard mass spectrum.

When the analyst indicates an arbitrary peak in the standard mass spectrum displayed as described above using a pointing device, for example, the extracted ion chromatogram display processing means receives this indication, creates an extracted ion chromatogram of an actual measurement for the mass of the indicated peak, and displays the chromatogram on the display screen. The extracted ion chromatogram at this time may be displayed in an overlapping manner with the total ion current chromatogram (in a form in which they can be distinguished from one another such as a form with different line colors), or it may be displayed independently in a different area of the same screen. If a plurality of peaks are indicated in a mass spectrum, extracted ion chromatograms for the masses of the plurality of indicated peaks should be created and displayed in an overlapping manner in one graph with different line colors or the like. As a result, it is possible to draw a plurality of extracted ion chromatograms and compare their shapes with a simple operation such as the clicking operation of a mouse.

In addition, in the chromatograph mass spectrometry data processing device of the present invention, instead of the standard mass spectrum, the spectrum display processing means may arrange differential mass spectra obtained by subtracting a standard mass spectrum with uniformly adjusted intensities from the actual measurement mass spectra vertically with the same mass axis scale as the actual measurement mass spectra. The “standard mass spectrum with uniformly adjusted intensities” is a mass spectrum obtained by multiplying a uniformly determined scaling factor by each intensity so that the intensity of each peak in the standard mass spectrum does not exceed that in the actual measurement mass spectrum.

With this configuration, the differences between the intensities of each of the peaks of the actual measurement mass spectra and the standard mass spectrum can be understood at a glance, which makes it even easier to grasp whether there is any overlapping of contaminant components other than the components to be confirmed in the actual measurement mass spectra.

With the chromatograph mass spectrometry data processing device of the present invention, it is possible for an analyst to easily—that is, with a simple operation—and accurately confirm whether contaminant components other than a target component overlap with an arbitrary peak of a chromatogram based on the intensity patterns of the mass spectrum. In addition, when the overlapping of components is suspected from a comparison of the intensity patterns of the mass spectrum, it is possible to confirm the waveform of an extracted ion chromatogram corresponding to a suspicious peak with an extremely simple operation. As a result, when performing operations such as the confirmation of whether a target component is present in a sample or the identification of contained components, the confirmation operation performed visually by the analyst is simplified, which improves efficiency, and operational mistakes are also reduced, which improves the reliability of the results.

### BRIEF DESCRIPTION OF THE DRAWINGS

FIG. 1 is a schematic block diagram of an embodiment of a GC-MS system containing the data processing device of the present invention.

FIG. 2 is a drawing which schematically shows data collected by the GC-MS system of this embodiment.

FIG. 3 is a flowchart showing an example of the procedure for component identification in the GC-MS system of this embodiment.

FIG. 4 is a schematic diagram showing an example of the display screen in the GC-MS system of this embodiment.

### DETAILED DESCRIPTION OF THE EXEMPLARY EMBODIMENTS

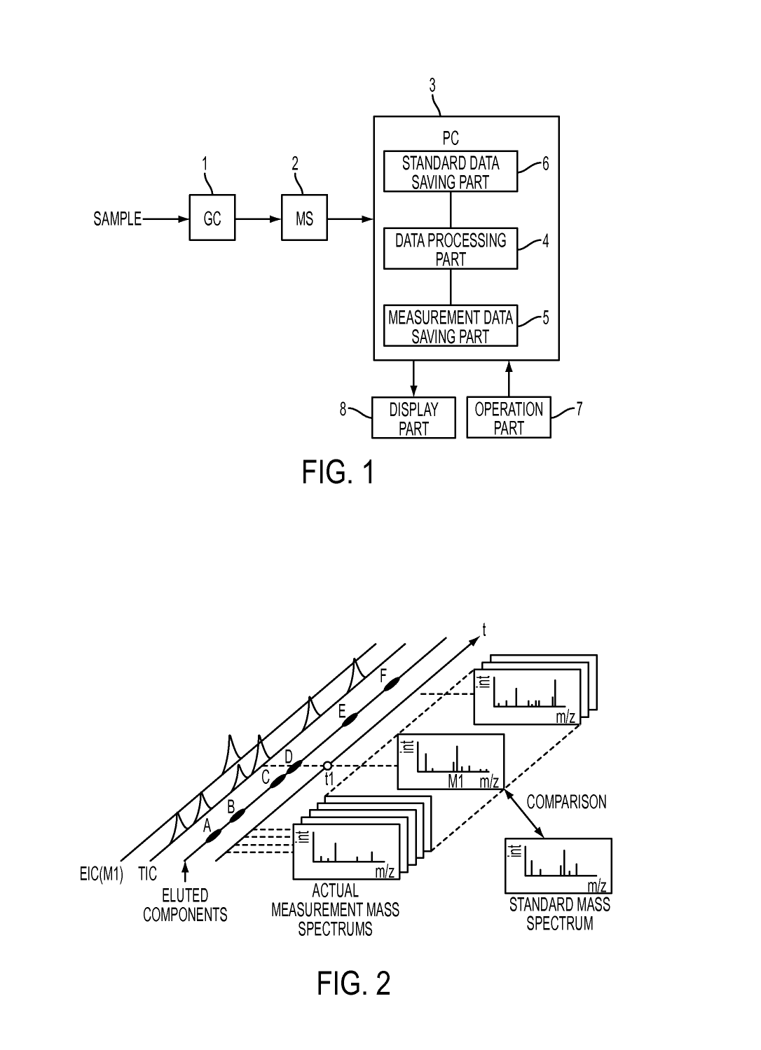

A GC-MS system containing the chromatograph mass spectrometry data processing device of the present invention will be described below with reference to the attached drawings. FIG. 1 is a schematic block diagram of an embodiment of a GC-MS system according to this embodiment.

This system is provided with a gas chromatograph (GC) 1 for separating components contained in a sample over time, a mass spectrometer (MS) 2 for separating and detecting each of the separated components according to the mass-charge ratio (strictly speaking, m/z), and a personal computer (PC) 3 for processing data obtained by the MS 2. Dedicated data processing software is installed in the PC 3, the functions of a data processing part 4, a measurement data saving part 5, a standard data saving part 6, and the like shown in the drawing are realized by executing this software with the PC 3. In addition, an operation part 7, which is a pointing device such as a keyboard or a mouse, and a display part 8 are connected to the PC 3.

FIG. 2 is a schematic diagram for explaining data collected at the time of analysis in the GC-MS system described above. The data collection operation of the GC-MS system will be explained using FIGS. 1 and 2.

When a sample is introduced into the GC 1, the components contained in the sample are separated and eluted while they are passed through a column (not shown). In the example shown in FIG. 2, six types of components A, B, C, D, E, and F are eluted at different times. In the MS 2, scan measurements involving mass scans of prescribed mass ranges are repeated at regular time intervals. One scanning measurement (mass scan) yields data (mass spectrum data) constituting one actual measurement mass spectrum such as that shown in FIG. 2. Accordingly, the actual measurement mass spectrums are obtained at the predetermined time intervals by repeating the scan measurements at the predetermined time intervals. All of the ion intensities contained in a single actual measurement mass spectrum are added, and a plot of the results in the time direction is a total ion current chromatogram (TIC). A graph in which attention is focused on only specific mass-charge ratios and the ion intensities of the mass-charge ratios are plotted in the time direction is an extracted ion chromatogram (EIC). In the example of FIG. 2, an EIC for a mass M1 corresponding to peaks appearing in the actual measurement mass spectrum at time t1 is shown.

In the GC-MS system of this embodiment, mass spectrum data is repeatedly collected as described above from the point when one sample is introduced into the GC 1 (or a point delayed by a prescribed amount of time thereafter) until a point delayed by an appropriate amount of time after the components in the sample are completely eluted, and this is consolidated into a single data file and stored in the measurement data saving part 5. The measurement data stored in the measurement data saving part 5 is read into the data processing part 4 when designated by the analyst and is used in reanalysis for the purpose of component identification or the like.

On the other hand, the retention times, the characteristic masses, the standard mass spectra, and the like of various compounds are registered in advance in the standard data saving part 6. A typically provided database such as the NIST, Wiley, or Drug database may be used directly as this standard data saving part 6, or a part of the database may be extracted and used. In addition, a database or the like created independently by a device manufacturer and provided to the user or a database obtained based on measurements of standard substances taken by the user himself may also be used.

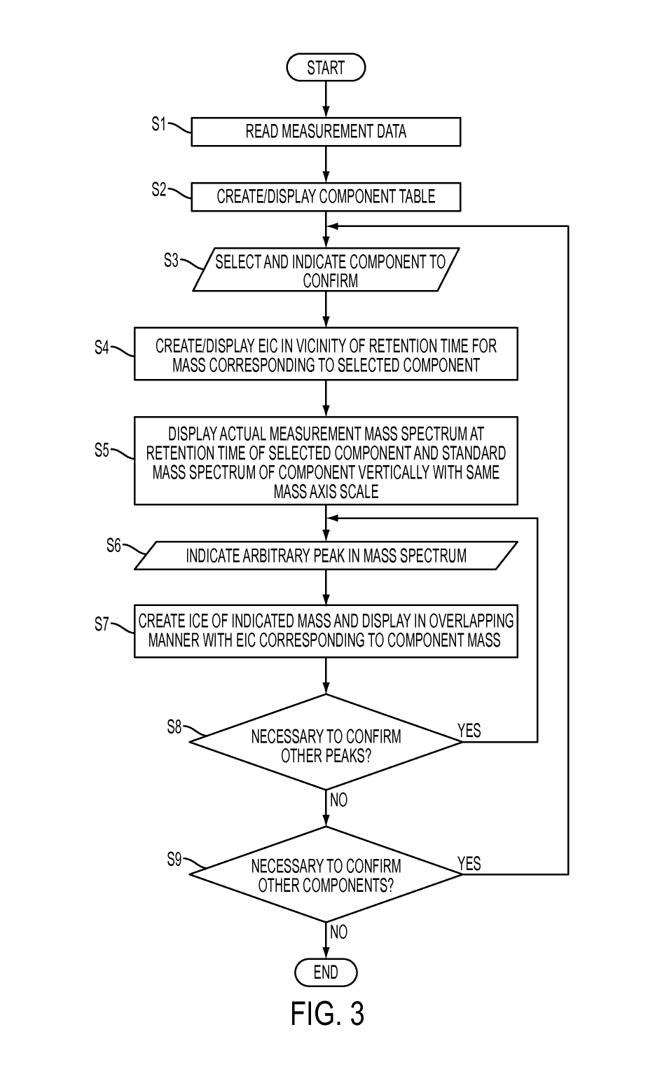

Next, data processing characteristic to the GC-MS system of this embodiment—more specifically, data processing for supporting the confirmation operation performed by the analyst when identifying components—will be described in accordance with the flowchart shown in FIG. 3.

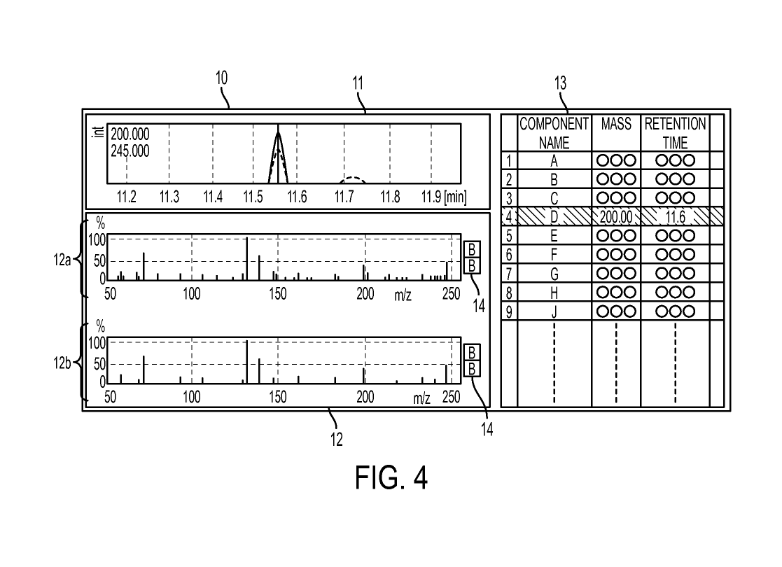

FIG. 4 is a schematic diagram showing an example of the screen displayed on the display part 8 at the time of this processing. Various display areas such as a chromatogram display area 11, a mass spectrum display area 12, and a component table display area 13 are respectively marked out and arranged in the data reanalysis screen 10 shown in FIG. 4. The details of the graphs or tables displayed in each of the display areas will be described below.

When the analyst performs a prescribed operation with the operation part 7 in order to specify data to be analyzed, the data processing part 4 reads the measurement data stored in the measurement data saving part 5 as data to be processed (step S1). The data processing part 4 also extracts information regarding the compounds designated in a method file in which the analytical conditions used to obtain the measurement data that is read out are stored from the standard data saving part 6, creates a component table in which the component names, masses, retention times, and the like are listed, and displays this in the component table display area 13 (step S2). The components displayed in this component table display area 13 are components to be identified or components for which presence or absence is to be confirmed in this reanalysis.

The analyst selects and designates one of the components by moving the cursor to the component to be confirmed in the displayed component table and performing the clicking operation (step S3). In the example shown in FIG. 4, component D is designated, and as a result, the row containing component D is highlighted so that it can be recognized that the component has been selected. The data processing part 4 receives the indication of the selection of the component, obtains the characteristic mass information corresponding to the component, and creates an EIC of the mass based on the measurement data. An EIC of a prescribed time range in the vicinity of the retention time of the component is then displayed in the chromatogram display area 11 (step S4).

The data processing part 4 creates an actual measurement mass spectrum at the retention time of the selected component based on the measurement data and displays the mass spectrum in the upper level 12a of the mass spectrum display area 12. Further, a standard mass spectrum registered in advance in association with the selected component is displayed in the lower level 12b of the mass spectrum display area 12 with the same mass axis scale as the actual measurement mass spectrum (step S5). The intensity axes of both mass spectra are standardized so that the maximum intensity is 100%. The mass axis can be magnified or reduced by a dragging operation using a mouse or the operation of the magnification/reduction button 14 displayed to the right of each mass spectrum, but even when magnification/reduction is performed with one of the mass spectra of the upper or lower levels 12a or 12b, the mass axis of the other mass spectrum is also magnified/reduced concurrently. Therefore, the scales of the mass axes are aligned in the upper and lower mass spectra, regardless of the magnification/reduction operation. As a result, the analyst can easily compare the intensity patterns of both mass spectra, which makes it possible, for example, to accurately grasp at a glance that there is a peak in the actual measurement mass spectrum of the upper level 12a corresponding to a mass without a peak in the standard mass spectrum of the lower level 12b or situations in which the intensity ratios of a plurality of peaks of the same mass differ greatly between the two mass spectra.

The actual measurement mass spectrum displayed in the upper level 12a of the mass spectrum display area 12 may also be a mass spectrum at the time of the top of the peak of the actual measurement TIC or EIC in the vicinity of the retention time rather than at the retention time of the selected component.

If there is a peak suspected of having overlapping contaminant components as a result of the comparison of the actual measurement mass spectrum and the standard mass spectrum, in order to confirm this, the analyst moves the cursor above or to the vicinity of the peak to be confirmed in the displayed standard mass spectrum or actual measurement mass spectrum and selects and indicates the peak by means of a double clicking operation (step S6). The data processing part 4 receives the selection and indication of this peak, creates an EIC of the mass corresponding to the peak based on the measurement data, and displays the EIC in an overlapping manner with the EIC displayed in the chromatogram display area 11 using a different line color (step S7). As long as the upper limit of the number of EICs that can be displayed simultaneously in the chromatogram display area 11 (for example, 8, 12, or the like) has not been reached, a different EIC is additively displayed in an overlapping manner each time a peak is newly designated (Yes in step S8). As a result, an EIC of the mass of a spectrum peak suspected of having overlapping contaminant components or a peak suspected to be a contaminant component can be confirmed with a simple operation.

If the analyst wishes to similarly confirm another component differing from the component specified previously in the component table (Yes in step S9), the analyst should designate another component in the component table. In this way, with the GC-MS system of this embodiment, it is possible for the analyst to compare the intensity patterns of an actual measurement mass spectrum and a standard mass spectrum or to confirm the waveform of an EIC of the mass corresponding to a suspicious peak with a simple operation at the time of operations such as component identification based on previously collected measurement data.

In the embodiment described above, the standard mass spectrum of the designated component was displayed without modification below the actual measurement mass spectrum in the mass spectrum display area 12, but alternatively, a differential mass spectrum indicating the intensity difference between the actual measurement mass spectrum and the standard mass spectrum may be created and displayed. However, since the intensity may be a negative value when the difference between the intensities is simply taken, the differential mass spectrum should be found by multiplying a predetermined scaling factor by the intensity of each peak of the standard mass spectrum and subtracting this from the intensity of each peak of the actual measurement mass spectrum so that the intensity of each peak of the standard mass spectrum does not exceed the intensity of each peak of the actual measurement mass spectrum. As a result, it becomes even easier to grasp the difference between the intensities of the two mass spectra, and in particular, it becomes possible for even an analyst with comparatively little experience with analysis to implement analysis without mistakes.

Moreover, the embodiment described above is merely an example of the present invention, and it is clear that appropriate variations, modifications, or additions made within a scope adhering to the gist of the present invention are also included in the scope of the patent claims of this application.

### EXPLANATION OF SYMBOLS

1 . . . gas chromatograph (GC)
2 . . . mass spectrometer (MS)
3 . . . personal computer (PC)
4 . . . data processing part
5 . . . measurement data saving part
6 . . . standard data saving part
7 . . . operation part
8 . . . display part
10 . . . data reanalysis screen
11 . . . chromatogram display area
12 . . . mass spectrum display area
13 . . . component table display area
14 . . . magnification/reduction button

What is claimed is:

1. A chromatograph mass spectrometry data processing device for creating total ion current chromatograms showing changes in total ions over time and actual measurement mass spectra at arbitrary points in time in the chromatogram based on mass spectrum data repeatedly collected over time by chromatograph mass spectrometry and displaying them on a display screen, said device being provided with:
a) a storage means for storing a standard mass spectrum for various components;
b) a spectrum display processing means for arranging the standard mass spectrum and said actual measurement mass spectra of a component designated to be confirmed among the various components stored in said storage means vertically with the same mass axis scale, displaying the spectra on the same screen as said total ion current chromatogram, and concurrently performing magnification/reduction operations on said actual measurement mass spectra and the standard mass spectrum in the mass axis direction; and
c) an extracted ion chromatogram display processing means for receiving an indication of an arbitrary peak in the standard mass spectrum or an actual measurement mass spectrum displayed on the display screen by said spectrum display processing means, creating an extracted ion chromatogram with respect to the mass of the indicated peak based on said mass spectrum data, and displaying the chromatogram on the same screen as said actual measurement mass spectra and the standard mass spectrum.

2. The chromatograph mass spectrometry data processing device according to claim 1, wherein:
instead of said standard mass spectrum, said spectrum display processing means arranges differential mass spectra obtained by subtracting a standard mass spectrum with uniformly adjusted intensities from said actual measurement mass spectra vertically with the same mass axis scale as the actual measurement mass spectra.
